(19) United States
(12) Patent Application Publication
(10) Pub. No.: US 2026/0193010 A1
(43) Pub. Date: Jul. 9, 2026

(54) HOLLOW PLATE BUFFER BOX STRUCTURE AND PREPARATION METHOD THEREOF

(71) Applicant: NINGBO ANSOL CABINET CO., LTD., Ningbo (CN)

(72) Inventor: Limin Yuan, Ningbo (CN)

(21) Appl. No.: 19/421,435

(22) Filed: Dec. 16, 2025

(30) Foreign Application Priority Data
Jan. 7, 2025 (CN) 202510021351.9

(51) Int. Cl. B65D 81/127; B29C 53/06; B29C 65/60; B29L 31/00

(52) U.S. Cl. CPC B65D 81/127; B29C 53/063; B29C 65/603; B29L 2031/7162; B65D 2581/055

(57) ABSTRACT

A hollow plate buffer box structure and a preparation method thereof, comprising a box body hollow plate, a box body enclosed by the hollow plate, and rivets, the box body hollow plate has a double-layer hollow structure with inner and outer walls; the material is cut using laser or die-cutting, with crease lines and fixing holes cut out; after folding the box into shape, it is secured with rivets, then as the final packaging for the product. Compared with the packaging method that uses packaging auxiliary materials and cardboard boxes, it can significantly simplify the packaging process; the box body hollow plate has excellent cushioning properties, eliminates use of non-environmentally friendly materials such as foam, protecting the environment; it has high strength, moisture-proof, water-resistant, and anti-mildew properties; compared with cardboard boxes, it has a better resistance to harsh environments; by increasing the wall thickness, its strength can be enhanced.

### TECHNICAL FIELD

The invention relates to the technical field of packaging materials, in particular to a hollow plate buffer box structure and a preparation method thereof.

### BACKGROUND ART

When transporting household appliances such as refrigerators, washing machines, air conditioners, and range hoods, as well as furniture and cabinet products, protection is generally achieved using foam boards, EPE foam sheets (pearl cotton), honeycomb cardboard, and corrugated cardboard to prevent damage during transportation and handling.

Currently on the market, cushioning materials such as foam, EPE foam, and honeycomb cardboard are only used as auxiliary packaging materials to achieve a cushioning effect, followed by the use of a cardboard box as the final packaging. This packaging design process is complicated in steps and inconvenient to operate. Furthermore, it offers poor moisture and water resistance, is prone to mold and mildew, has low strength, and provides an unsatisfactory protective effect.

### SUMMARY OF THE INVENTION

In order to achieve the above purpose, the invention provides the following technical solution: a hollow plate buffer box structure and a preparation method thereof, comprising a box body hollow plate, a box body enclosed by the hollow plate, and rivets, wherein the box body hollow plate has a double-layer hollow structure with inner and outer walls, the inner wall of the box body hollow plate is covered with grooves in an arch shape along a depth direction, and the outer wall of the box body hollow plate is flat;

the inner wall of the box body hollow plate is divided into several main folding panels by crease lines, two ends of the main folding panels are divided into two auxiliary folding panels by the crease lines, the box body hollow plate is folded inward along the crease lines to form the box body, and the box body is fixed by the rivets.

As a preferred technical solution of the invention, the grooves have a V-shaped, U-shaped, or arc-shaped cross-section, and the grooves deepen in an arch shape along the depth direction, with deepest depression at intersection points of the grooves.

As a preferred technical solution of the invention, the depression is deepest at the intersection points of two adjacent grooves, and the deepest point of the depression is connected to the outer wall.

As a preferred technical solution of the invention, positions corresponding to the main folding panels at two pre-connected ends of the box body hollow plate are respectively provided with an extension plate and first fixing holes, an interior of the extension plate is provided with second fixing holes corresponding to the first fixing holes.

As a preferred technical solution of the invention, positions on the box body hollow plate corresponding to the auxiliary folding panels are respectively provided with corresponding third fixing holes and fourth fixing holes.

As a preferred technical solution of the invention, the structure further comprises rivets, one end of each rivet is provided with an inclined undercut, and a middle of its axis has a gap; when the rivet is pressed into the hole, the inclined undercut shrinks inward toward an axis diameter due to force on an inclined surface; once fully inserted, external force disappears, and the inclined undercut pops open to lock and fix; after the box body hollow plate is folded into the box, the rivets are inserted into the first fixing holes and the second fixing holes, as well as the third fixing holes and fourth fixing holes.

A preparation method of the hollow plate buffer box structure comprises the following steps:

S1: the hollow plate is processed and formed, using blow molding or rotational molding processes to create a box body hollow plate with arch-shaped grooves on the wall surface;

S2: the hollow plate is cut and shaped, according to the unfolded dimensions of the box body, laser cutting or die cutting is used to cut the required outer dimensions of the box body hollow plate, including the fixing holes;

S3: setting the crease lines, laser cutting is used to create the crease lines on the inner wall that need to be folded, or a V-shaped crease line is heat-pressed onto the inner wall where folding is required;

S4: folding along the crease lines to form the box, the box body hollow plate is folded inward into the box shape according to the crease lines;

S5: sealing the box, after folding the box body hollow plate into the box shape, the first fixing holes and the second fixing holes align, and the third fixing holes and the fourth fixing holes align; finally, the rivets are inserted to complete the fixation of the box body.

As a preferred technical solution of the invention, the box body hollow plate forming the box body is configured from a single piece that is connected end-to-end, or it is configured from separate pieces that are connected and fixed together.

As a preferred technical solution of the invention, in S3, the crease lines formed by laser cutting are narrow striped rectangles or dashed lines.

As a preferred technical solution of the invention, in S5, after folding the box body hollow plate into the box, in addition to using the rivets, the box body can also be fixed using one, two or more combinations selected from plastic expansion nails, Velcro, cardboard rivets, glue, or high-temperature welding.

Compared with the prior art, the hollow plate buffer box structure and the preparation method thereof provided by the invention have the following advantageous effects:

compared with the packaging method that uses packaging auxiliary materials and cardboard boxes on the market, the hollow plate buffer box structure and the preparation method thereof can significantly simplify the packaging process; additionally, the box body hollow plate has excellent cushioning properties, eliminates the use of non-environmentally friendly materials such as foam, thus protecting the environment; moreover, it has high strength, moisture-proof, water-resistant, and anti-mildew properties; compared with cardboard boxes, it has a better resistance to harsh environments; by increasing the wall thickness, its strength can be enhanced; it can replace traditional packaging methods such as wooden boxes, wooden frames, and wooden pallets; this provides convenience for the normal express logistics transportation of overweight and oversized products.

### BRIEF DESCRIPTION OF ACCOMPANYING DRAWINGS

FIG. 1 is a schematic diagram of the box body hollow plate folded into a box according to the hollow plate buffer box structure and the preparation method thereof proposed in this invention.

FIG. 2 is a schematic diagram of the rivets of the hollow plate buffer box structure and the preparation method thereof proposed in this invention.

FIG. 3 is a schematic diagram of the unfolded box body hollow plate according to the hollow plate buffer box structure and the preparation method thereof proposed in this invention.

FIG. 4 is a side view of the unfolded box body hollow plate according to the hollow plate buffer box structure and the preparation method thereof proposed in this invention.

FIG. 5 is a schematic diagram of the unfolded box body hollow plate according to the hollow plate buffer box structure and the preparation method thereof proposed in this invention.

FIG. 6 is an enlarged view of the structure at point A in FIG. 5.

FIG. 7 is a side view of the box body hollow plate folded into the box according to the hollow plate buffer box structure and the preparation method thereof proposed in this invention.

FIG. 8 is a cross-sectional view of the structure at point A-A in FIG. 7.

FIG. 9 is an enlarged view of the structure at point A in FIG. 8.

FIG. 10 is a top view of the box body hollow plate folded into the box according to the hollow plate buffer box structure and the preparation method thereof proposed in this invention.

FIG. 11 is a cross-sectional view of the structure at point B-B in FIG. 10.

FIG. 12 is an enlarged view of the structure at point A in FIG. 11.

FIG. 13 is a flowchart of the preparation process of the hollow plate buffer box structure and the preparation method thereof proposed in this invention.

In the figures: 1 box body hollow plate; 2 box body; 11 inner wall; 111 groove; 112 main folding panel; 113 auxiliary folding panel; 12 outer wall; 13 crease line; 14 extension plate; 15 first fixing hole; 16 second fixing hole; 17 third fixing hole; 18 fourth fixing hole; 19 rivet; 191 inclined undercut.

### SPECIFIC EMBODIMENT OF THE INVENTION

The technical schemes in the embodiments of the invention will be clearly and completely described in combination with the accompanying drawings in the embodiments of the invention. Obviously, the described embodiments are only some of the embodiments of the invention, but not all of the embodiments. Based on the embodiments in this invention, all other embodiments obtained by those of ordinary skill in the art without making creative efforts shall fall within the protection scope of this invention.

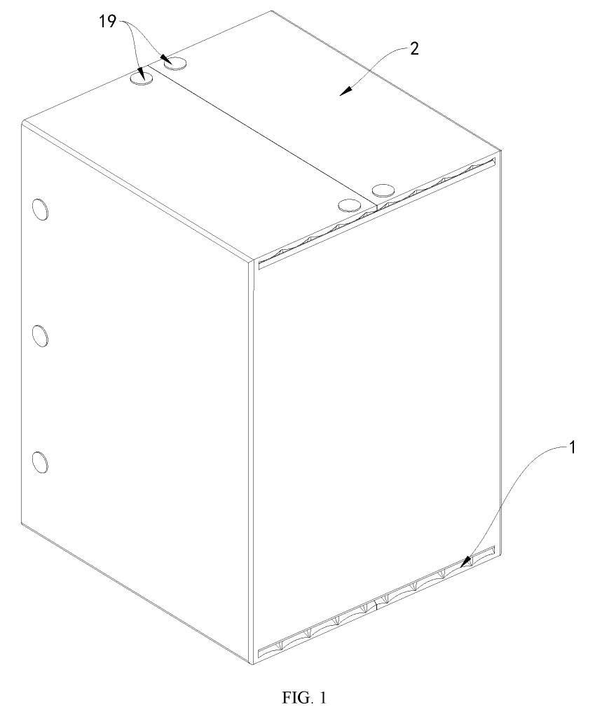

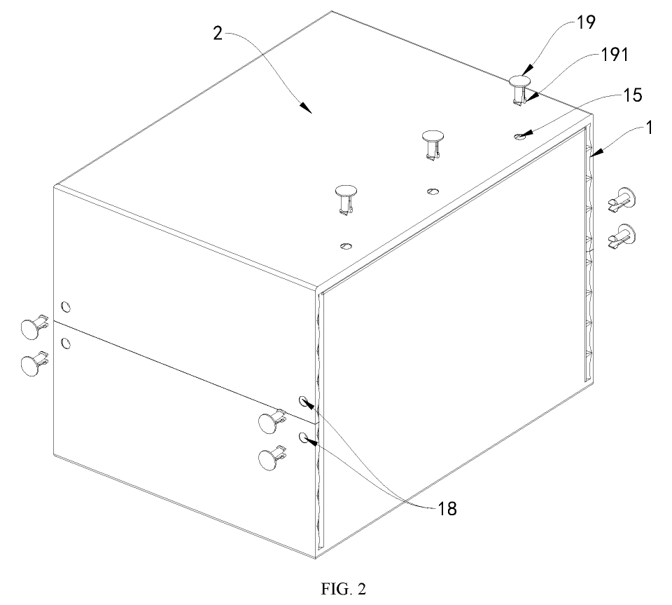

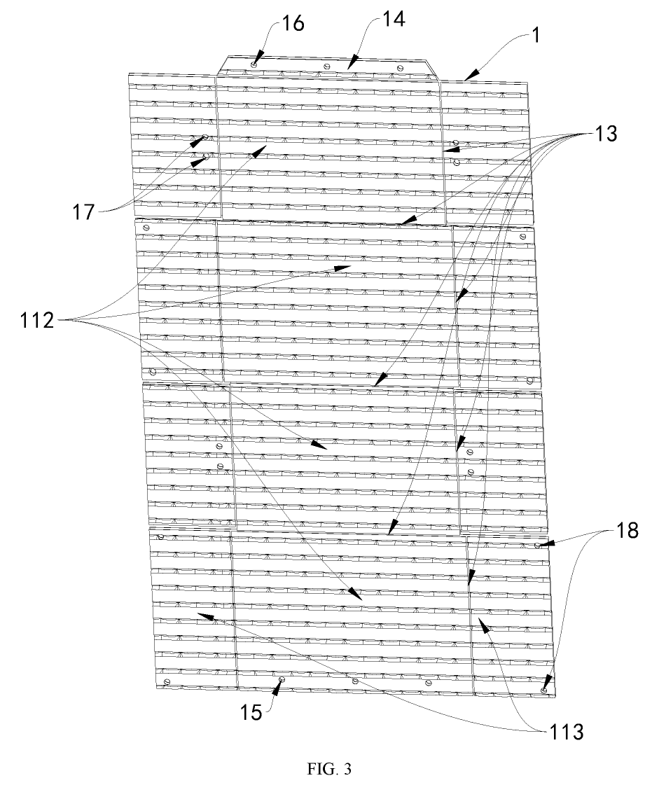

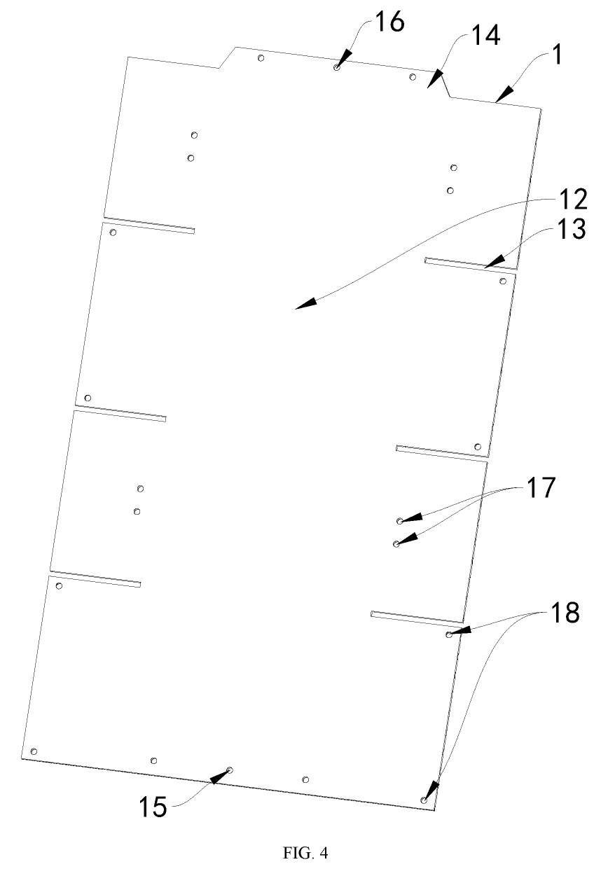

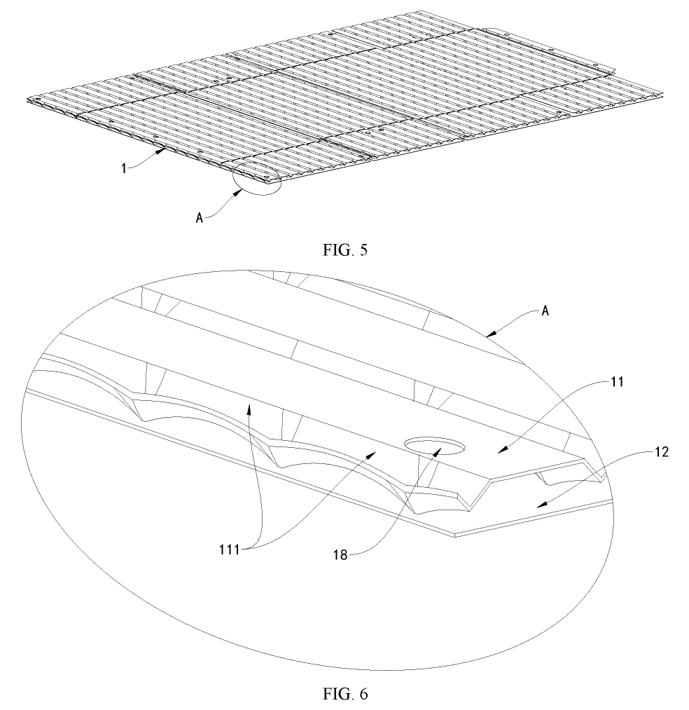

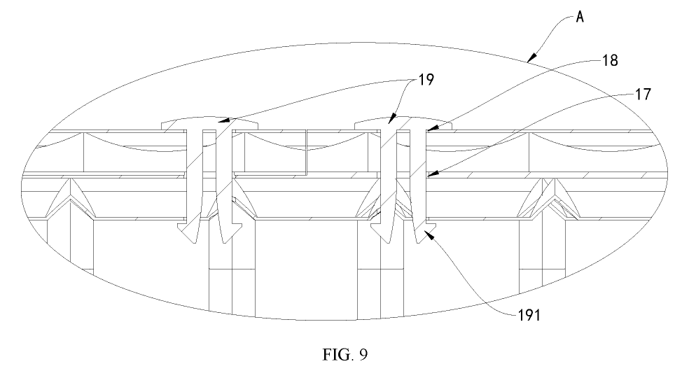

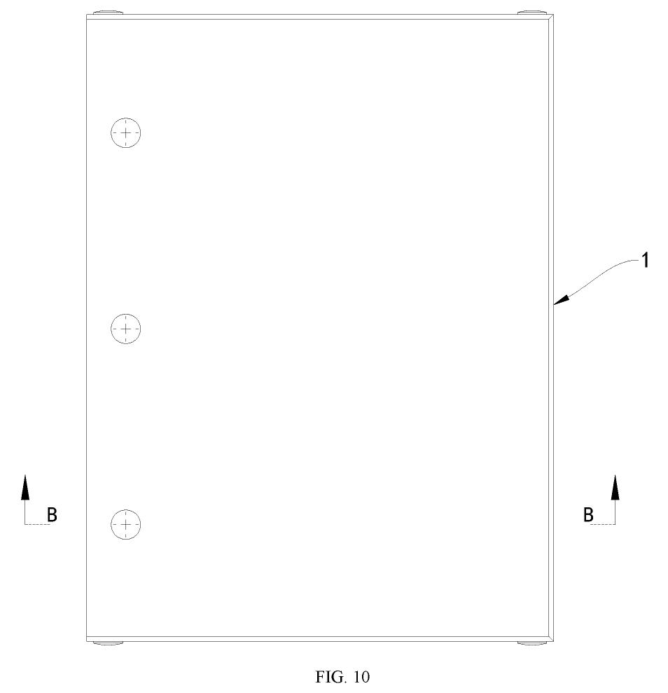

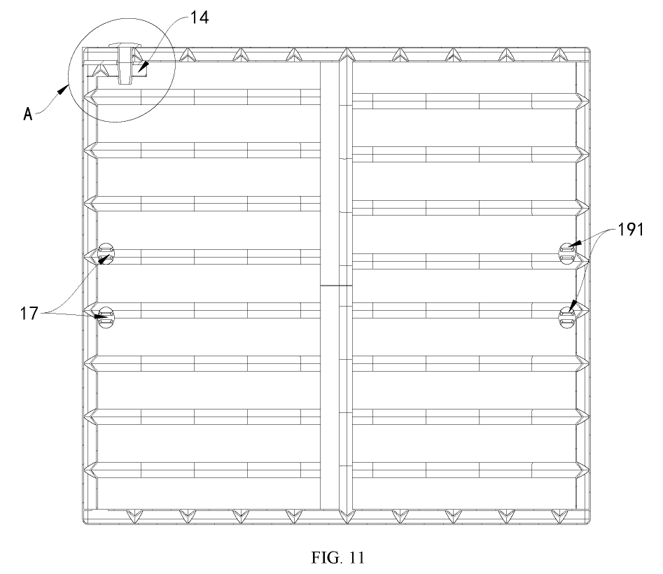

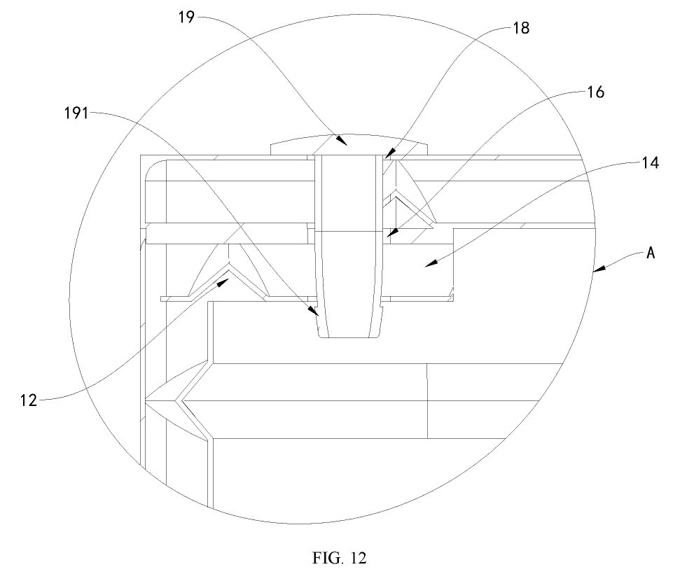

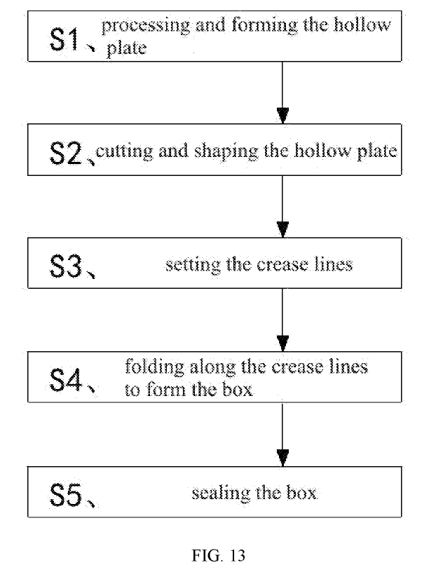

Referring to FIG. 1 to FIG. 13, a hollow plate buffer box structure and a preparation method thereof, comprising a box body hollow plate 1, a box body 2 enclosed by the hollow plate, and rivets 19, the box body hollow plate 1 has a double-layer hollow structure with inner and outer walls, the inner wall 11 of the box body hollow plate 1 is covered with grooves 111 in an arch shape along a depth direction, and the outer wall 12 of the box body hollow plate 1 is flat; when the box body hollow plate 1 is processed and formed, the strength of the box body hollow plate 1 can be increased by increasing the wall thickness of the inner wall 11 and outer wall 12, which can replace the traditional packaging methods such as wooden boxes, wooden frames, and wooden pallets, providing convenience for the normal express logistics transportation of overweight and oversized products.

The inner wall 11 of the box body hollow plate 1 is divided into several main folding panels 112 by crease lines 13, two ends of the main folding panels 112 are divided into two auxiliary folding panels 113 by the crease lines 13, the box body hollow plate 1 is folded inward along the crease lines 13 to form the box body 2, and the box body 2 is fixed by the rivets 19.

Compared with the packaging method that uses packaging auxiliary materials and cardboard boxes on the market, using the box body 2 made from folding the box body hollow plate 1 significantly simplifies the packaging process. Additionally, the box body 2 has moisture-proof, water-resistant, and anti-mildew properties. Compared with cardboard boxes, the box body 2 has a better resistance to harsh environments, simplifies packaging, and eliminates the use of non-environmentally friendly materials such as foam, thus protecting the environment. Moreover, it has excellent strength and can be used as a packaging box for heavy and large products. By increasing the wall thickness of the inner wall 11 and outer wall 12, its strength can be enhanced. It can replace traditional packaging methods such as wooden boxes, wooden frames, and wooden pallets. This provides convenience for the normal express logistics transportation of overweight and oversized products. Its structure is simplified and compact, aligning with economic benefits, and it has broad application prospects.

As one specific technical solution in this embodiment, the grooves 111 have a V-shaped, U-shaped, or arc-shaped cross-section, and the grooves 111 deepen in an arch shape along the depth direction, with deepest depression at intersection points of the grooves 111.

In this implementation solution, the grooves 111 divide the entire large area of the wall into numerous small units, greatly increasing the strength of the wall; the cross-section of each groove 111 is in the shape of a V, U, or arc; this design allows the grooves 111 to support the cavity between the inner wall 11 and outer wall 12.

As one specific technical solution in this embodiment, the depression is deepest at the intersection points of two adjacent grooves 111, and the deepest point of the depression is connected to the outer wall 12.

In this implementation solution, this structural design creates multiple support points between the inner wall 11 and outer wall 12; the numerous intersections of the grooves 111 form many support points that support the entire inner wall 11 and outer wall 12; this strengthens the support between the inner wall 11 and outer wall 12, greatly enhancing the cushioning performance of the box body hollow plate 1, making it more resistant to impact and less likely to damage the items protected inside the box body 2.

As one specific technical solution in this embodiment, positions corresponding to the main folding panels 112 at two pre-connected ends of the box body hollow plate 1 are respectively provided with an extension plate 14 and first fixing holes 15, an interior of the extension plate 14 is provided with second fixing holes 16 corresponding to the first fixing holes 15; positions on the box body hollow plate 1 corresponding to the auxiliary folding panels 113 are respectively provided with corresponding third fixing holes 17 and fourth fixing holes 18, the box structure further comprises rivets 19, one end of each rivet 19 is provided with an inclined undercut 191, and a middle of its axis has a gap; when the rivet 19 is pressed into the hole, the inclined undercut 191 shrinks inward toward an axis diameter due to force on an inclined surface; once fully inserted, external force disappears, and the inclined undercut 191 pops open to lock and fix; after the box body hollow plate 1 is folded into the box, the rivets 19 are inserted into the first fixing holes 15 and the second fixing holes 16, as well as the third fixing holes 17 and fourth fixing holes 18.

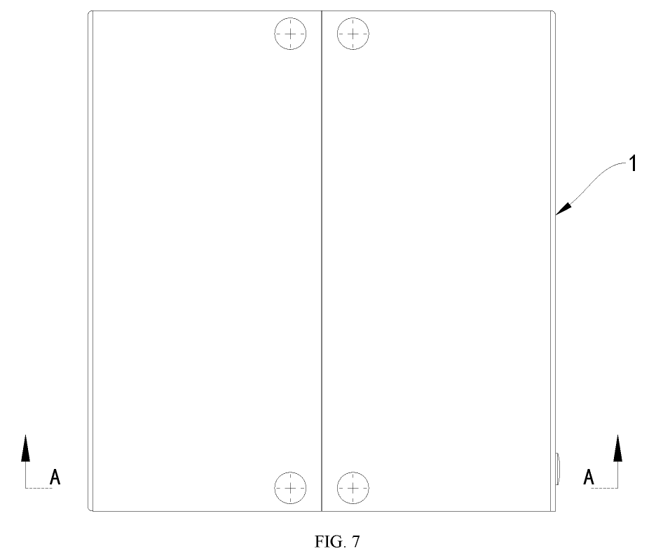

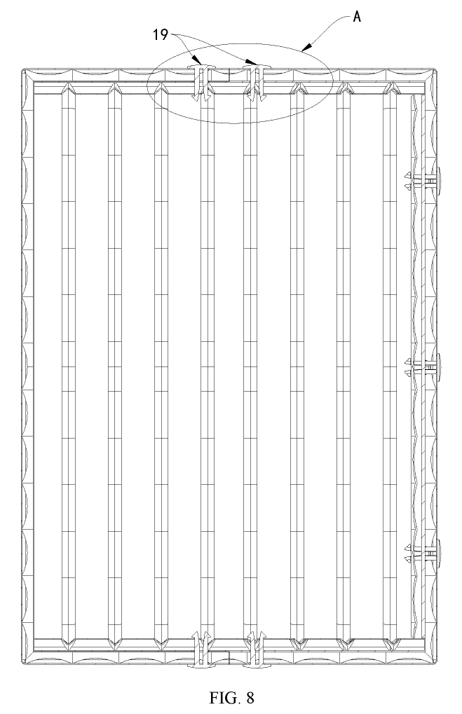

In this implementation solution, referring to FIGS. 7-12, when the box body hollow plate 1 is folded into a box, there are four main folding panels 112 in total. The main folding panels 112 at both ends of the box body hollow plate 1 are joined together, so that the four main folding panels 112 form four sides of the box body 2. The extension plate 14 on the main folding page 112 at a front end of the box body hollow plate 1 is snapped into an inner side of the main folding page 112 at a rear end of the box body hollow plate 1, so that the positions of the second fixing holes 16 and the first fixing holes 15 are aligned. The rivets 19 are then inserted from an outside of the box body 2, passing through the first fixing holes 15 and the second fixing holes 16 to enter an inner side of the box body 2, completing the connection of the front and rear ends of the box body hollow plate 1, and the box body 2 is initially formed. The box body hollow plate 1 is made of plastic materials such as PE, PP, or nylon, which are tough and flexible. Therefore, the box body hollow plate 1 has toughness and a locally compressible property.

After the box body hollow plate 1 is folded into a box, the corresponding hole positions on the box body hollow plate 1 are aligned one by one, and the portions of the box body hollow plate 1 corresponding to the auxiliary folding panels 113 partially overlap; the rivets 19 are pressed, and the first box body hollow plate 1 is pressed into the second box body hollow plate 1, the first box body hollow plate 1 is locally flattened, causing the expanding heads of the rivets 19 to be compressed so that they can pass through the fixing holes; after the rivets 19 enters an interior of the second box body hollow plate 1 and then released, the first box body hollow plate 1 rebounds, allowing the inclined undercuts 191 of the rivets 19 to be firmly locked onto an inner wall 11 of the second box body hollow plate 1; in this way, the two overlapping box body hollow plates 1 are securely connected together. This connection method is simple and convenient; due to the tensile force, outer diameters of the inclined undercuts 191 in free state are larger than diameters of the fixing holes, which not only ensures a firm connection, but also makes it difficult to disengage or be damaged. This connection method can be completed without the aid of other tools and has broad versatility and applicability.

A preparation method of the hollow plate buffer box structure comprises the following steps:

S1: the hollow plate is processed and formed, using blow molding or rotational molding processes to create a box body hollow plate 1 with arch-shaped grooves 111 on the wall surface; the arched grooves 111 on the inner wall 11 reinforce the wall surface; the arched grooves 111 deepen in an arc toward an interior of the cavity until they meet at intersection points; these numerous intersection points support the entire inner and outer wall 12 structure; the arched structure not only allows the intersection points to serve as supports for both the inner and outer walls, but also provides excellent buffering capacity; furthermore, the arched structure allows the blow molding gas to pass through the arched cavities, thereby facilitating excellent blow molding formation;

S2: the hollow plate is cut and shaped, according to the unfolded dimensions of the box body 2, laser cutting or die cutting is used to cut the required outer dimensions of the box body hollow plate 1, including the fixing holes, encompassing connecting holes or lifting holes required to be set on both the interior and exterior of the box body 2;

S3: setting the crease lines 13, laser cutting is used to create the crease lines 13 on the inner wall 11 that need to be folded, or a V-shaped crease line 13 is heat-pressed onto the inner wall 11 where folding is required;

S4: folding along the crease lines 13 to form the box, the box body hollow plate 1 is folded inward into the box shape according to the crease lines 13;

S5: sealing the box, after folding the box body hollow plate 1 into the box shape, the first fixing holes 15 and the second fixing holes 16 align, and the third fixing holes 17 and the fourth fixing holes 18 align; finally, the rivets 19 are inserted to complete the fixation of the box body 2.

As one specific technical solution in this embodiment, the box body hollow plate 1 forming the box body 2 is configured from a single piece that is connected end-to-end, or it is configured from separate pieces that are connected and fixed together.

As one specific technical solution in this embodiment, in S3, the crease lines 13 formed by laser cutting are narrow striped rectangles or dashed lines.

In this implementation solution, the crease line 13 is created by laser cutting or blade cutting, where the inner wall 11 at the folding area is cut into a narrow rectangular or dashed line, while the outer wall 12 is left intact without damaging it, thus not affecting the appearance. In this way, when folding the box into shape, the cut inner wall 11 has minimal resistance to folding. The outer wall 12 is made of tough plastic materials such as PE, PP, or nylon, which can be bent; this allows easy folding along the predetermined crease line 13 to form the box. The strength of an inner wall 11 along the crease line 13 can also be weakened by pressure or heat pressing to facilitate guiding the folding process along the crease line 13.

As one specific technical solution in this embodiment, in S5, after folding the box body hollow plate 1 into the box, in addition to using the rivets 19, the box body 2 can also be fixed using one, two or more combinations selected from plastic expansion nails, Velcro, cardboard rivets, glue, or high-temperature welding.

In this implementation solution, after the two ends of the box body hollow plate are connected, the items that need to be protected can be placed inside the box body 2; then, the auxiliary folding panels 113 are folded so that the third fixing holes 17 and the fourth fixing holes 18 align with each other; the rivets 19 can be snapped into the third fixing holes 17 and the fourth fixing holes 18 to seal the box. Alternatively, one or more methods such as Velcro, cardboard rivets, glue, or high-temperature welding can also be used to seal or further reinforce the box body 2, making it more convenient to use.

In summary, compared with the packaging method that uses packaging auxiliary materials and cardboard boxes on the market, the hollow plate buffer box structure and the preparation method thereof adopt the box body 2 made from folding the box body hollow plate 1, which can significantly simplify the packaging process; additionally, it has moisture-proof, water-resistant, and anti-mildew properties; compared with cardboard boxes, it has a better resistance to harsh environments, simplifies packaging, and eliminates the use of non-environmentally friendly materials such as foam, thus protecting the environment; moreover, it has excellent strength and can be used as a packaging box for heavy and large products; by increasing the wall thickness of the inner wall 11 and outer wall 12, its strength can be enhanced; it can replace traditional packaging methods such as wooden boxes, wooden frames, and wooden pallets; this provides convenience for the normal express logistics transportation of overweight and oversized products; its structure is simplified and compact, aligning with economic benefits, and it has broad application prospects.

It should be noted that in this article, the terms “comprises”, “includes” or any other variation thereof are intended to cover a non-exclusive inclusion such that a process, method, article or apparatus including a list of elements includes not only those elements, but also includes other elements not expressly listed, or also includes the elements inherent to such process, method, article or apparatus. Without further limitation, an element defined by the statement “comprises a...” does not exclude the presence of additional identical elements in a process, method, article, or apparatus that includes the stated element.

Although the embodiments of the invention have been shown and described above, it should be understood that those skilled in the art can make changes, modifications, substitutions and alterations to the above embodiments without departing from the principles and spirit of the invention. The scope of the invention is defined by the claims and their equivalents.

1. A hollow plate buffer box structure, comprising a box body hollow plate, a box body enclosed by the hollow plate, and rivets, wherein the box body hollow plate has a double-layer hollow structure with inner and outer walls, the inner wall of the box body hollow plate is covered with grooves in an arch shape along a depth direction, and the outer wall of the box body hollow plate is flat;
the inner wall of the box body hollow plate is divided into several main folding panels by crease lines, two ends of the main folding panels are divided into two auxiliary folding panels by the crease lines, the box body hollow plate is folded inward along the crease lines to form the box body, and the box body is fixed by the rivets.

2. The hollow plate buffer box structure of claim 1, wherein the grooves have a V-shaped, U-shaped, or arc-shaped cross-section, and the grooves deepen in an arch shape along the depth direction, with deepest depression at intersection points of the grooves.

3. The hollow plate buffer box structure of claim 1, wherein the depression is deepest at the intersection points of two adjacent grooves, and the deepest point of the depression is connected to the outer wall.

4. The hollow plate buffer box structure of claim 1, wherein positions corresponding to the main folding panels at two pre-connected ends of the box body hollow plate are respectively provided with an extension plate and first fixing holes, an interior of the extension plate is provided with second fixing holes corresponding to the first fixing holes.

5. The hollow plate buffer box structure of claim 4, wherein positions on the box body hollow plate corresponding to the auxiliary folding panels are respectively provided with corresponding third fixing holes and fourth fixing holes.

6. The hollow plate buffer box structure of claim 5, wherein the structure further comprises rivets, one end of each rivet is provided with an inclined undercut, and a middle of its axis has a gap; when the rivet is pressed into the hole, the inclined undercut shrinks inward toward an axis diameter due to force on an inclined surface; once fully inserted, external force disappears, and the inclined undercut pops open to lock and fix; after the box body hollow plate is folded into the box, the rivets are inserted into the first fixing holes and the second fixing holes, as well as the third fixing holes and fourth fixing holes.

7. A preparation method of the hollow plate buffer box structure of claim 6, comprising following steps:
S1: the hollow plate is processed and formed, using blow molding or rotational molding processes to create a box body hollow plate with arch-shaped grooves on the wall surface;
S2: the hollow plate is cut and shaped, according to the unfolded dimensions of the box body, laser cutting or die cutting is used to cut the required outer dimensions of the box body hollow plate, including the fixing holes;
S3: setting the crease lines, laser cutting is used to create the crease lines on the inner wall that need to be folded, or a V-shaped crease line is heat-pressed onto the inner wall where folding is required;
S4: folding along the crease lines to form the box, the box body hollow plate is folded inward into the box shape according to the crease lines;
S5: sealing the box, after folding the box body hollow plate into the box shape, the first fixing holes and the second fixing holes align, and the third fixing holes and the fourth fixing holes align; finally, the rivets are inserted to complete the fixation of the box body.

8. The hollow plate buffer box structure and its preparation method of claim 7, wherein the box body hollow plate forming the box body is configured from a single piece that is connected end-to-end, or it is configured from separate pieces that are connected and fixed together.

9. The hollow plate buffer box structure and its preparation method of claim 7, wherein in S3, the crease lines formed by laser cutting are narrow striped rectangles or dashed lines.

10. The hollow plate buffer box structure and its preparation method of claim 7, wherein in S5, after folding the box body hollow plate into the box, in addition to using the rivets, the box body can also be fixed using one, two or more combinations selected from plastic expansion nails, Velcro, cardboard rivets, glue, or high-temperature welding.
